(19) United States
(12) Patent Application Publication
(10) Pub. No.: US 2012/0240938 A1
(43) Pub. Date: Sep. 27, 2012

(54) METHODS AND SYSTEMS FOR PERFORMING HIP JOINT DISTRACTION

(76) Inventor: Christo Pamichev, Cupertino, CA (US)

(21) Appl. No.: 13/418,149

(22) Filed: Mar. 12, 2012

Related U.S. Application Data
(60) Provisional application No. 61/454,583, filed on Mar. 21, 2011.

(51) Int. Cl. A61G 15/00

(52) U.S. Cl. 128/845

(57) ABSTRACT

A method and system for distracting a patient's hip joint are disclosed. The method allows for free movement and re-positioning of the hip joint during hip arthroscopy or other surgical procedures while the hip joint remains distracted and located at a fix point of rotation. The system comprises a frame, leg support, a first pivot assembly, a second pivot assembly, and a rotation assembly.

### CROSS-REFERENCE TO RELATED APPLICATION

This application claims the benefit of provisional application No. 61/454,583 (Attorney Docket No. 42628-703.101), filed on Mar. 21, 2011, the full disclosure of which is incorporated herein by reference.

### BACKGROUND OF THE INVENTION

1. Field of the Invention

The present invention relates generally to medical methods and systems. More particularly, the present invention relates to a system and method of its use for distracting and pre-positioning a leg and distracting a hip joint to allow access for hip arthroscopy, open surgery, and other surgical and non-surgical procedures, as well as for examination.

To gain access to a hip joint to perform hip arthroscopy, the femoral head must be pulled away (distracted) from the socket in the pelvis. A variety of devices and protocols are known to provide such distraction. Typically, the patient is placed in a supine (lying on the back) or lateral (lying on the side) position, and the hip is anchored by attachment to a surgical table, use of a peroneal post (a post positioned between the patient's legs), or often a combination of both. Tension is then applied to the ankle or other region of the leg, with the leg straight or slightly bent to position the femoral head relative to the socket while the joint remains distracted.

While functional, these methods and systems suffer from certain shortcoming. During distraction, the nerves in and around the hip joint are stretched, and the duration of the procedure must be limited in order to prevent injury to these nerves. The pressure against the peroneal post during distraction can reduce or entirely block blood flow to the lower leg, increasing the risk of deep vein thrombosis. Additionally, most or all present distraction systems limit movement of the leg while the hip joint is distracted, thus necessitating repeated cycles of distraction and release from distraction should repositioning of the femoral head be desired. Third, to the extent existing distraction mechanisms allow the leg to pivot and rotate, the point of rotation of those system lies several inches away from the true center of the femoral head. Such displacement will disproportionately change the degree of distraction and greatly limit the physician from repositioning the leg without the need to release the joint from distraction, as discussed above.

These limitations, when taken together, not only increase the risk to the patients, they also lengthen the procedure time and make the procedure more complex for the treating physician. To overcome these difficulties, some physicians will distract the hip joint more than might otherwise be necessary. Distracting hip joint more than the procedure requires can also risk unnecessary injury to the patient.

For all these reasons, it would be desirable to provide improved methods and systems for distracting the hip during hip arthroplasty and other surgical interventions. It would be particularly desirable if the methods and systems permitted the physician to conveniently distract the hip joint at the beginning of the procedure, allow the physician to freely reposition the leg and the hip joint during the procedure while maintaining the initial distraction with minimum disturbance, and allow the physician to freely access the hip joint to perform a desired surgical procedure regardless of the degree of distraction and position of the leg and hip joint. At least some of these objectives will be met by the inventions described below.

2. Description of the Background Art

Relevant patents and published applications include: U.S. Pat. No. 7,947,006; U.S. Pat. No. 7,832,401; U.S. Pat. No. 7,677,249; U.S. Pat. No. 5,802,641; (Reissue Pat. No. 41,412); U.S. Pat. No. 5,608,934; U.S. Pat. No. 5,162,039; U.S. Pat. No. 5,025,802; US2011/0190676; US2009/0182340; US2009/0105710; and US2006/0100562.

### SUMMARY OF THE INVENTION

The present invention provides methods and systems for distracting a hip joint during hip arthroscopy and other surgical and examination procedures. The methods and systems of the present invention are particularly advantageous since they allow a very simple protocol for the initial distraction of the hip joint, provide the physician with the freedom to reposition the hip joint during the surgical procedure while maintaining the initial distraction, allowing the physician to periodically relieve distraction during the procedure, and providing the physician with complete access to the hip joint with minimal or no interference from the system used for the hip distraction.

In a first aspect of the present invention, methods for distracting a patient's hip joint comprise supporting a leg on a repositionable leg support with the knee bent and the hip distracted. The leg support may be freely repositioned in a first plane, typically to allow the hip joint to move in a first plane in the medial and lateral directions (referred to as adduction and abduction) while the hip joint remains distracted and located at a fixed point of rotation. The method further comprises repositioning the leg support in a second plane perpendicular to the first plane, to allow flexion and extension of the hip joint while the hip joint remains distracted and located at the fixed point of rotation. The methods still further comprise rotating the leg support about an axis generally aligned with the femur and intersecting the fixed point of rotation, typically to provide internal and external rotation of the hip joint, while the hip joint remains distracted and located at the fixed point of rotation.

The ability of the present invention to manipulate the leg support in such a way that the hip joint is caused to rotate about a fixed point of rotation which coincides with the physiological point of rotation of the hip joint itself, opens new possibilities to physicians and provides better access to certain areas of the hip joint. The present invention allows the leg to be distracted in an anatomically easier position and the leg to then be moved to a surgically or otherwise convenient position. Such movement will lower the maximum pressure applied in the groin area during the distraction, thus minimizing the risk of injuries. The present invention further allows for rapid and precise distraction and release of distraction, which in return can reduce the total time distraction is applied during the procedure and reduce trauma to nerves and soft tissue in the hip joint area. In preferred aspects, the present invention further allows for “indexing” of the system so that, after temporary release of distraction, the system can be returned to a previous configuration to return the leg to the same position and level of distraction as before the release.

The methods may further comprise bending the knee while the leg support engages the lower leg at a point below the knee so that the lower leg acts as a lever and applies tension to the upper leg and femur to distract the hip joint. This aspect of the invention allows the physician to conveniently establish the initial hip joint distraction and further allows the initial distraction to be maintained (or re-established as noted above) by simply holding or locking the knee in the initial bent position throughout the remainder of the procedure.

In other specific aspects of this method, the leg support may be selectively locked or otherwise be prevented from movement in any one or more of the first or second planes or rotational aspects. Typically, the leg support will be selectively locked to prevent movement in the first and second planes as well as to prevent rotation while the arthroscopy or other surgical procedure is being performed. Additionally, the leg support will typically be locked in at least two of the available repositioning and rotating movements while it is being repositioned and the other of the movements. This allows the leg support and hip joint to be effectively repositioned in only one of the three degrees of freedom (while the remaining two remain locked). Alternatively, in other embodiments of the present invention, the leg support and hip joint may be repositionable and rotatable in all three movements simultaneously, allowing the hip to be freely repositioned and subsequently locked when the desired position is reached.

In a second aspect of the present invention, a method for distracting a patient's hip joint comprises immobilizing the patient's hip joint on a table with the hip joint at a point of rotation. Tension is applied to the patient's femur to distract the hip joint, and the lower leg and femur may then be pivoted on a first plane while the hip joint remains distracted and at the point of rotation, typically to allow adduction and abduction of the joint. The lower leg and femur may further be pivoted in a second plane perpendicular to the first plane while the hip joint remains distracted and at the point of rotation, typically to allow flexion and extension of the hip joint. Finally, the lower leg may be located about an axis of rotation aligned with the femur and intersecting the point of rotation while the hip joint remains distracted and at the point of rotation, typically to allow internal and external rotation of the hip joint.

The methods of the present invention may be performed with the patient lying in a supine or lateral position, and the patient will typically be positioned over a peroneal post or other structure immobilizing the patient's groin.

Tension may be applied to the femur in at least three ways. As illustrated in the drawings hereinafter, tension may be applied by flexing the knee with a location on the lower leg held against a fulcrum structure so that the knee is drawn away from the torso to apply tension to the femur (thigh or upper leg) to distract the hip joint. Usually, the fulcrum structure comprises the upper end of a leg support which holds the lower leg. Alternatively, the fulcrum structure may be moved away from the hip to push the lower leg and apply tension on the knee support to distract the hip joint. In a third embodiment, the structure may combine both methods by applying tension on the knee support while flexing the knee.

Pivoting the lower leg and the femur in the first plane typically comprises engaging the lower leg or the upper leg and moving the leg through an arc in the first plane, typically in a lateral plane when the patient is in the supine position. The leg is typically secured in a leg support which is mechanically constrained to allow movement of the leg in the first plane without moving the location of the hip joint. The leg may be engaged either by manually repositioning the leg and the leg support or by actuating a mechanism to move the leg support which in turn repositions the leg. This mechanism may be controlled by a level mechanism or other mechanical actuator extending outside of a draped area over the patient. The draped area usually extends from the patient's abdomen and over the thigh. The lever may pass through portal(s) in the drape which allow access to the hip for performing the operation.

Pivoting the lower leg and femur in the second plane typically comprises engaging the lower leg or upper leg and moving the leg to an arc in the second plane. The second plane is typically a vertical plane while the patient is in the supine position. Engaging the leg usually comprises securing the leg in a leg support which is mechanically constrained to allow movement of the leg in the second plane without moving the location of the hip joint. Engaging the leg may comprise manually repositioning the leg and the leg support or may further comprise actuating a mechanism to move the leg support which in turn moves the leg. The mechanism may be controlled by a lever or other mechanical actuator that extends out of the draped area.

Rotating the lower leg about the axis of rotation typically comprises engaging the lower leg and applying torque to the lower leg to move the lower leg in a plane normal to the axis of rotation (when the leg is bent). Engaging typically comprises securing the leg and the leg support which is mechanically constrained to allow rotation of the lower leg without moving the location of the hip joint. Engaging may further comprise manually repositioning the lower and/or the leg support, or may further comprise actuating a mechanism to move the leg support which in turn rotates the lower leg. The rotation mechanism may be controlled by a lever or other mechanical actuator that extends out of the draped area.

In the further aspect of the present invention, a system for distracting and repositioning a hip joint comprises a frame, a leg support, a first pivot assembly, a second pivot assembly, and a rotation assembly. The pivotal and rotational assemblies are arranged to define a virtual point of rotation (which is located at a point in space away from all components of the system). The frame usually has markers to help position the patient so that the virtual point of rotation is coincident with the patient's hip joint. By “coincident, is meant that the virtual point of rotation is aligned closely or identically with the physiological center of rotation of the hip joint. It will be appreciated, of course, that some variance in the locations of the virtual and physiological centers will typically be present.

The leg support comprises a lower leg attachment member and a bracket. The lower leg attachment member is pivotally secured to the bracket, thus allowing bending of the knee and distraction of the hip joint as will be described in more detail hereinafter.

The first pivot assembly mechanically couples the bracket of the leg support to the frame and constrains the leg support to travel in an arc-like path in the first plane relative to the virtual point of rotation. The first pivot assembly will typically be directly attached to the frame, but in other embodiments could be attached indirectly to the frame.

The second pivot assembly mechanically couples the bracket of the leg support to the frame and constrains the leg support to travel in an arcuate path in a second plane which is perpendicular to the first plane. The second pivot assembly will typically be attached between the first pivot assembly and the rotation assembly, although any one of positions of these three assemblies may be interchanged.

The rotation assembly mechanically couples the bracket to the frame and constrains the bracket to be rotated about an axis extending radially from the virtual point of rotation, typically being aligned with the patient's femur. The rotation assembly is typically attached between the second pivot assembly and the leg support, but as noted above the positions of these assemblies may be interchanged.

In order to allow the leg and hip joint to be both repositioned and to be locked during the procedure, each of the first pivot assembly, the second pivot assembly, and the rotation assembly will include a locking mechanism so that the pivotal and rotational movement of the leg support can be selectively allowed and prevented. The locks may be active locking assemblies or alternatively may be frictional drivers which prevent movement of the assembly when they are not actively being actuated.

Additional locks or indexing mechanisms may be provided to allow the system to be returned to a previous configuration, typically after distraction has been temporarily released and/or the leg has been temporarily repositioned. Indexing systems may be as simple as providing indicia on the components so that an initial position can be recorded and subsequently re-established based on the indices. Often, the indexing system will comprise collars, pins, locks, or other components which may be set at any system configuration and allow any one or more of the pivotal and rotational assemblies to be returned to that set configuration. For motorized systems, the indexed configuration can be recorded by the system controller and be automatically re-established at any time. Thus, a variety of manual, automatic, and programmable indexing mechanisms can be utilized alone or in combination.

A particular advantage of this system is that the virtual point of rotation may be sufficiently offset from all mechanical components of the system to allow the hip joint to remain surgically accessible during the procedure regardless of the position of the leg support. In that way, the physician may freely reposition the leg and hip joint by manipulating the leg support without limiting his or her ability to perform the desire hip arthroscopy or other surgical procedure.

The frame may be constructed as a stand-alone surgical table, but will more typically be adapted to be removably secured to existing and conventional surgical tables.

As with the repositioning and rotation assemblies, the leg support will typically comprise a lock for selectively immobilizing the leg attachment member relative to the bracket. This allows the knee to be bent at a selective angle in order to provide a desired degree of hip joint distraction and to then be locked at that position during the remainder of the procedure and/or repositioned during the procedure if a different level of distraction is desired. The leg support may also comprise an indexing mechanism as described above.

The lower leg member will be adapted so that the lower leg may be secured at different positions or locations on the lower leg member so that the knee can be raised and lowered relative to the bracket. By raising and lowering the leg relative to the bracket, a different mechanical leverage can be obtained on the knee joint and femur to allow the physician to adjust the degree of hip distraction provided when the knee joint is bent, as described in the methods above.

In a specific embodiment of the system, the first pivot assembly comprises a support arm and a linkage assembly. The linkage assembly is attached to the frame, and the support arm is coupled to the second pivot assembly. The linkage assembly allows the support arm to reposition the leg support around the virtual point of rotation in the first plane. Such movement of the leg, of course, allows the hip joint to be adducted or abducted as described above in connection with the methods.

The second pivot assembly typically comprises a linkage assembly which is attached between the first pivot assembly and the rotation assembly. The second pivot assembly allows the leg support to be repositioned in the second plane about the virtual point of rotation. Such repositioning, of course, allows the hip joint to be flex or extended as described above in connection with the methods of the present invention. The linkage assembly of the second pivot assembly may comprise a parallelogram support structure, and the second pivot assembly may further comprise a driver adapted to manipulate the parallelogram structure to effect movement of the leg support.

The rotation assembly typically comprises a rocker assembly attached between the second pivot assembly and the bracket of the leg support. A rocker assembly allows the leg support to be rotated about the axis. The rocker assembly is useful since it allows the point of attachment of the rotation assembly to be offset from the axis of the leg supported on the leg support while still having the axis of rotation be aligned with the femur of the leg.

While the system and method as described above are particularly suitable for distracting a hip and repositioning the leg while the hip remains distracted, the systems are also used for hip distraction alone and for leg repositioning alone. In particular, the system can be used without distraction to collect data, track rehabilitation, map the anatomy, examine the patient, and for other activities before, during, and after surgical intervention.

The systems of the present invention will comprise at least the first and second pivotal assemblies and the rotation assembly. These assemblies will be mechanically coupled to the main frame either directly or indirectly, i.e., in tandem. Each of the assemblies may be actuated manually, via pre-loaded springs, using motors, or in any other way that such mechanical systems may be driven. The illustrated embodiments are suitable for manual actuation but could readily be adapted for motorized and/or automatic control.

The systems of the present invention could also be adapted to be driven to apply continuous or discontinuous motion to the leg for purposes of diagnosing and/or therapy for the hip and/or the knee.

In further embodiments, the motion of any of the movable assemblies can be free or be balanced by a spring, and the ranges of motion can be limited to allow leg and joint movements over certain ranges of motion but prevent them over other ranges of movement. All systems described herein could be used for rehabilitation purposes, after certain injuries or in relation with any medical intervention in the area of the joints.

The first and second pivotal assemblies, the rotation assembly, and the distraction assembly are all movable assemblies that can be actuated in a variety of ways, including manually, utilizing preloaded springs or using motors. In one embodiment of the present invention, the movement of each one of the movable assemblies can be controlled manually by the operator.

In further embodiments of the present invention, motors can be used to move any one or all of the moveable assemblies. The range of motion for each assembly can be pre-programmed, and the systems can be used to apply continuous motion to both hip and knee joints. The motion of any of the movable assemblies can be set to be free or to be balanced by a spring, and the range of motion can be limited to allow leg movements and movement of the joints in one area but prevent movement in other areas. The embodiments as described above individually or in combination, could be used for rehabilitation purposes, after certain injuries or in relation with any medical intervention in the area of the joints.

### BRIEF DESCRIPTION OF THE DRAWINGS

FIG. 1 illustrates the relevant anatomy of the hip.

FIG. 2 illustrates the Positioning and Distraction Apparatus (PDA) of the present invention attached to a surgical table.

FIG. 3 shows the PDA attached to a frame of a non-surgical table.

FIG. 4 is an exploded view of the three major functional components of PDA.

FIG. 5 is an exploded view of the Positioning and Distraction Mechanism (PDM) which provides for repositioning of the leg in the first and second orthogonal planes and for rotating the leg about a femoral axis.

FIG. 6 shows an abduction/adduction mechanism of the PDM of FIG. 5 in a position of complete adduction.

FIG. 7 shows the abduction/adduction mechanism of the PDM of FIG. 5 in a position of complete abduction.

FIG. 8 shows the abduction/adduction mechanism of the PDM of FIG. 5 in a position of transition between complete adduction (FIG. 6) and complete abduction (FIG. 7).

FIGS. 9-11 shows an abduction carriage which is part of the abduction/adduction mechanism of the PDM.

FIGS. 12-14 show a parallelogram mechanism which is part of the PDM of FIG. 5.

FIGS. 15-16 show a leg rotation mechanism which is part of the PDM of FIG. 5.

FIGS. 17-19 show three positions of the rotation mechanism and the distraction mechanism which are part of the PDM of FIG. 5.

FIGS. 20-21 show a distraction mechanism which is part of the PDM of FIG. 5.

FIG. 22 shows the peroneal post assembly which is part of the PDM of FIG. 5.

FIG. 23 shows a passive leg support, including a subframe, attached to the main frame.

FIGS. 24-28 show a patient positioned on an operating table with a right hip being distracted and a right leg being repositioned in accordance with the methods of the present invention.

### DETAILED DESCRIPTION OF THE INVENTION

Referring to FIG. 1, a hip joint comprises a “ball-and-socket” joint for a patient's femur has a femur head FH which is received in the acetabulum A (socket) of the hip H. This ball-and-socket joint allows the hip joint to move in three distinct motions referred to as flexion/extension when the leg moves in an anterior/posterior direction relative to the body. The second motion is referred to as adduction/abduction where the patient's postrious leg moves laterally in and out relative to the patient's body. Finally, the third motion of the hip joint comprises internal/external rotation where the leg rotates generally about an axis running through or parallel to the femur.

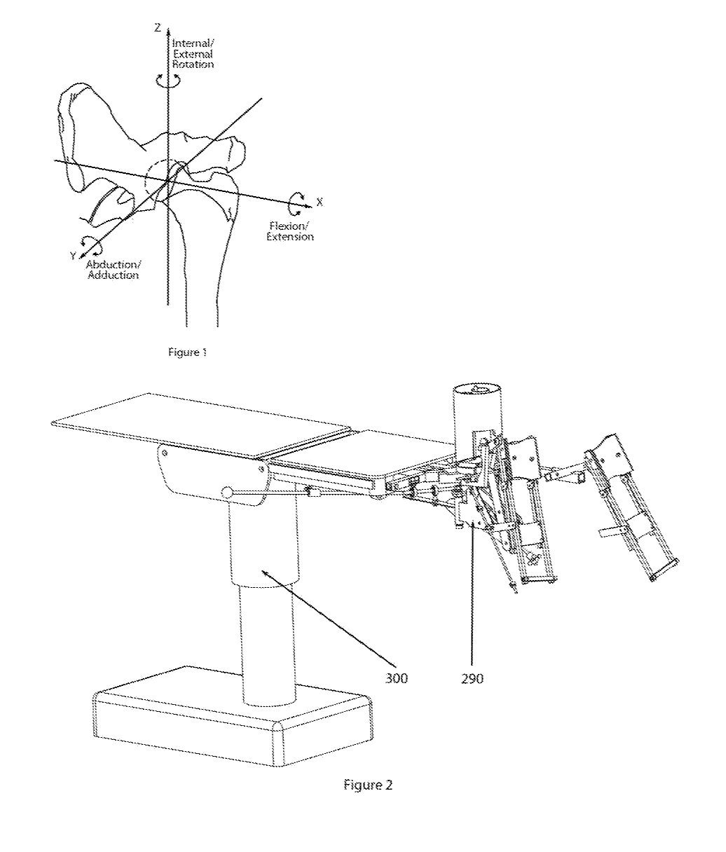

FIG. 2 provides a complete view of Positioning and Distraction Apparatus PDA 290 as it is attached to a surgical operating room table 300.

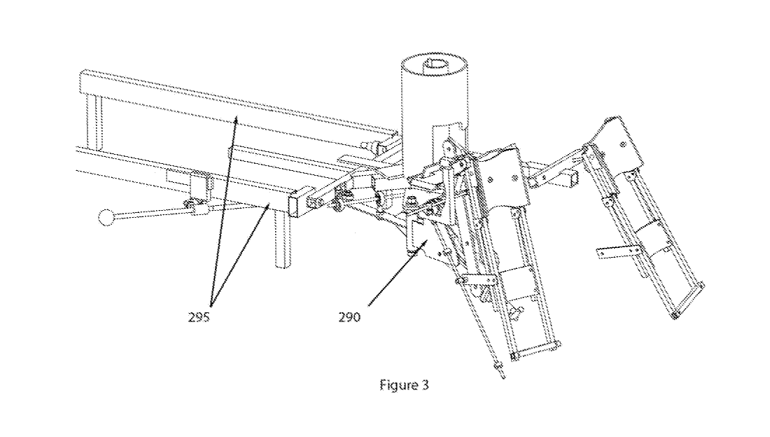

FIG. 3 shows PDA 290 attached to a frame of a non-surgical table 295 for the purpose of examination.

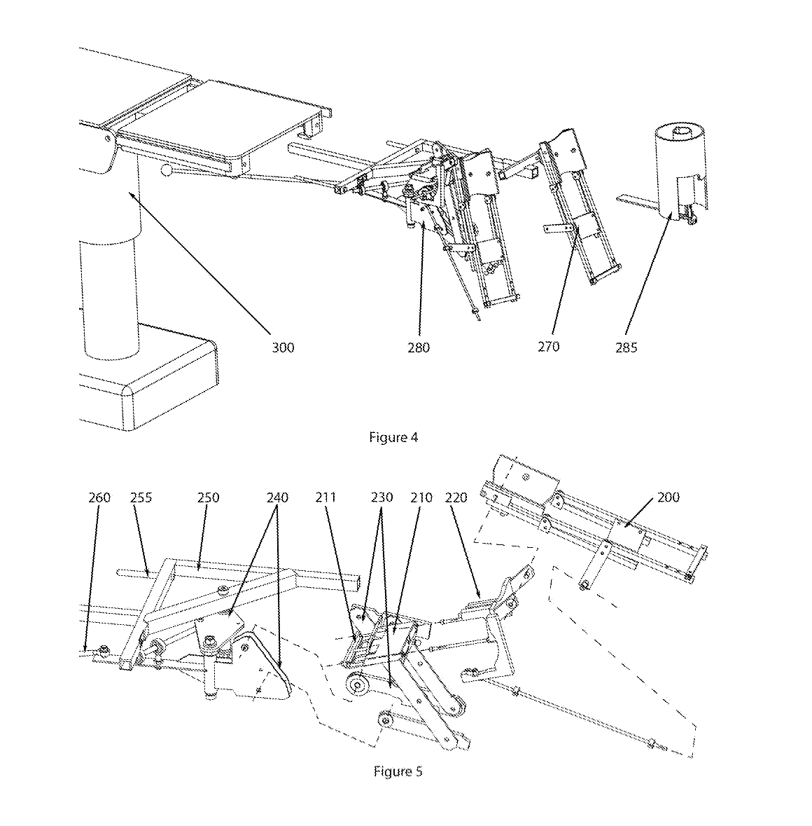

FIG. 4 shows the three major functional components of PDA 290, including a Positioning and Distraction Mechanism (PDM) 280 which provides for repositioning of the leg in the first and second orthogonal planes and for rotating the leg about a femoral axis, a Peroneal Post Assembly (PPA) 285 for stabilizing the patient's hip and groin during the distraction, and a Passive Leg Support Assembly (PLSA) 270 for supporting the leg while allowing flexion of the knee.

As shown in FIG. 5, PDM comprises a main frame 250 which attaches to OR table 300 via attachment pins 255. An abduction/adduction mechanism 240 is controlled by abduction control bar 260. A parallelogram mechanism 230 is responsible for flexion /extension motion and connects to a leg rotation mechanism 220 via rotation support plate 210 which is integrated with an upper leg length adjustment bracket 211. A distraction assembly 200 is pivotally attached to a rotation mechanism. Assembly paths are shown.

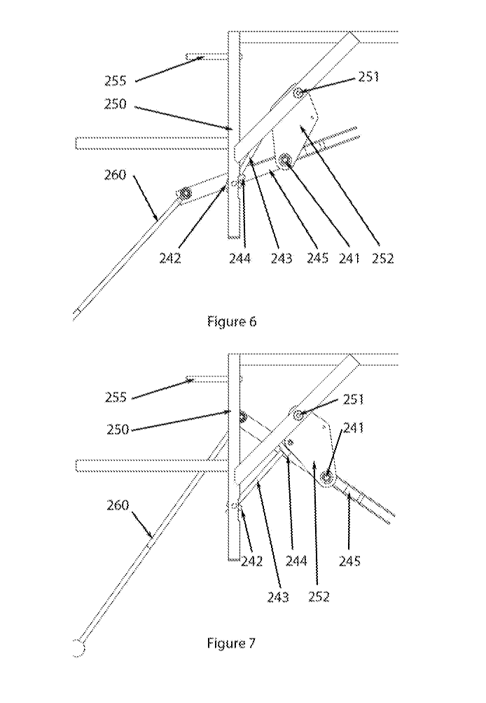

As shown in FIG. 6, the abduction/adduction mechanism 240 (FIG. 5) is in a position of complete adduction. Subframe 252 is pivotally attached to the main frame 250 via a main pivot 251. Subframe 252 supports abduction carriage 245 via secondary pivot 241. An abduction control bar 260 is supported by table support 261 and directly connected to the abduction carriage 245 which is guided by a main guide 243 via a linear guide 244. The main guide 243 is supported by the main frame 250 via linear support 242 and is pivotally attached to the subframe 252. Collars 262 and 263 are placed on control bar 260 and can be positioned by locking on the bar to selectively limit movement of the control bar in one or both directions. The collars then act as “stops” that can be used to retain and/or return the mechanism to a particular configuration.

As shown in FIG. 7, the abduction mechanism 240 (FIG. 4) is in a position of complete abduction. Abduction mechanism 240 supports abduction carriage 245 in a way that the later travels between the end positions on a trajectory close to an arc.

FIG. 8 is a composite drawing showing one central and two end positions of the abduction/adduction mechanism 240. Relative positions of the individual components are indicated by a “b,’ “c,” or “d” following the associated reference numeral. Position “b” represents full abduction. Position “d” represents full adduction, and position “c” represents a central position between full abduction and full adduction. Subframe 252 and the linear guide 244 are shown in each of the three positions. Main guide 243 is pivoted to the subframe 252 via pivot 247. The trajectory of pivoted connector 246 between abduction control bar 260 and abduction carriage 245 is shown as 246t. As the abduction carriage moves, its edge follows trajectory 245t. Both trajectories 245t and 246t closely follow an arc with center at VA-1 which is the position of the Virtual Axis 1 which is aligned with the patient's hip joint as shown in FIG. 1. All components attached to the abduction carriage 245 rotate around the vertical virtual axis VA-1. The abduction control bar 260 preferably extends outside the draped area (defined above) so that its handle remains accessible beyond the drape throughout the entire range of motion of the bar.

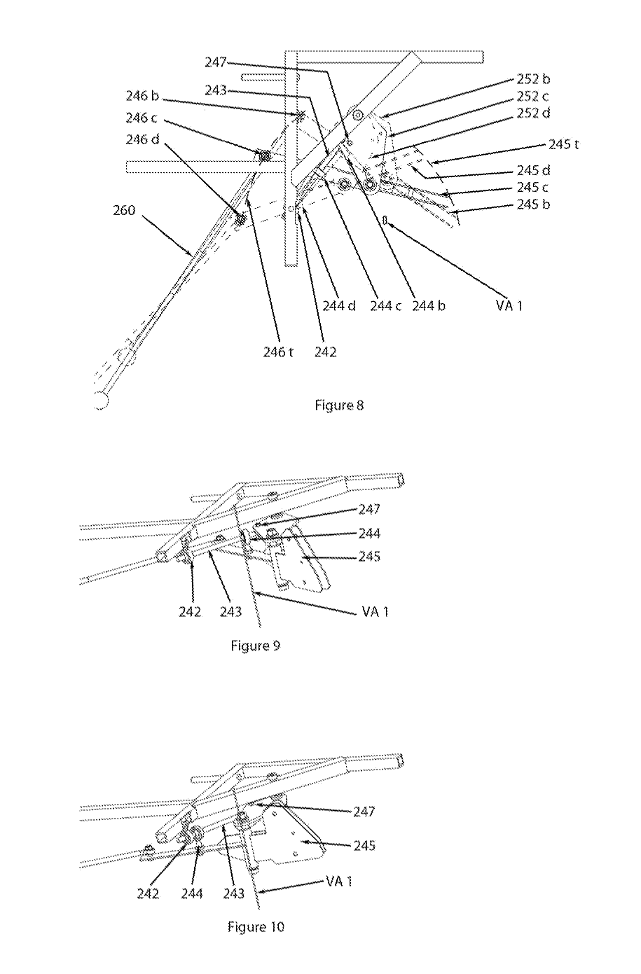

The abduction carriage 245 shown in FIG. 9 is in a close to complete abduction position when linear guide 244 is close to pivot 247 and remote from linear guide 242 while traveling on main guide 243. Abduction carriage 245 moves along a path that closely follows rotation around vertical virtual axis VA-1.

The abduction carriage 245 as shown in FIG. 10 is in a close to complete adduction position when linear guide 244 is close to linear guide 242 and remote from pivot 247 while traveling on main guide 243. Abduction carriage 245 moves in a way that closely resembles rotation around vertical Virtual Axis VA-1.

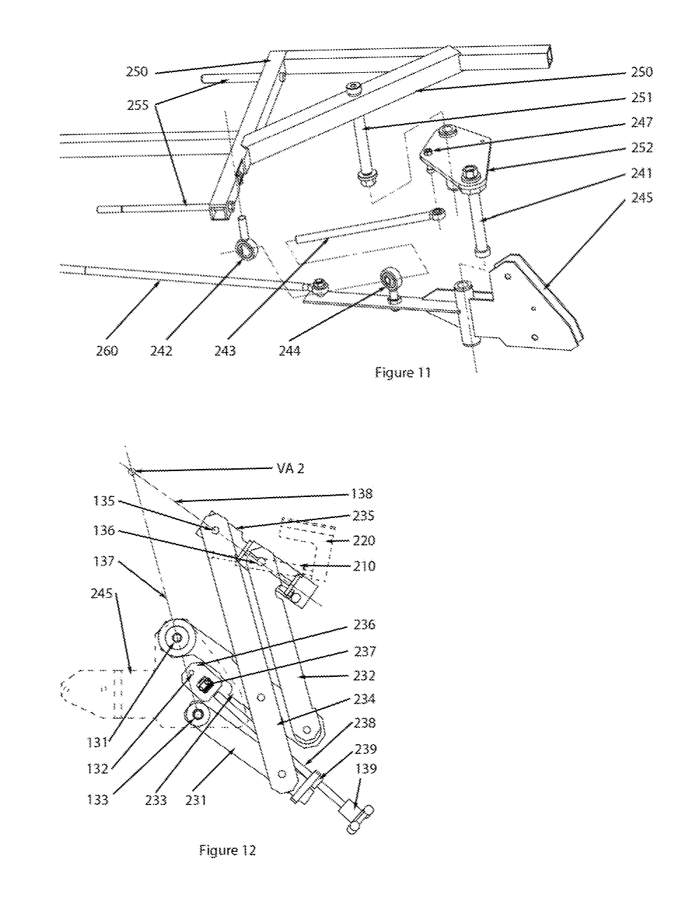

FIG. 11 is an exploded view showing the major assembly components of abduction mechanism 240 and the way they are assembled and attached to the main frame 250. Subframe 252 is pivotally attached to the main frame 250 via a main pivot 251. Subframe 252 supports abduction carriage 245 via a secondary pivot 241. Abduction control bar 260 is connected to the abduction carriage 245 which is guided by the main guide 243 via linear guide 244. Main guide 243 is supported by the main frame 250 via linear support 242 and is pivoted to the subframe 252 via pivot 247. Main frame mounting pins 255 are shown.

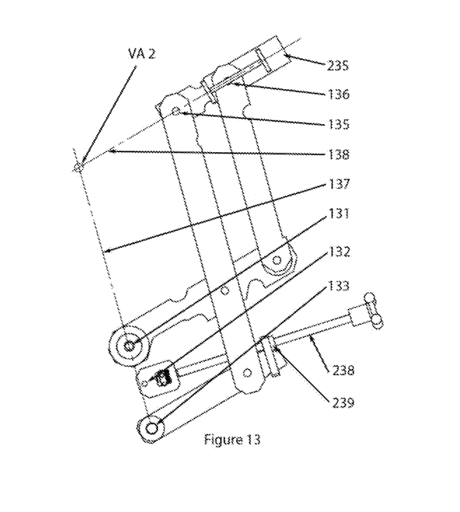

A parallelogram mechanism 230 is shown in FIGS. 12 and 13. The mechanism is attached to the abduction carriage 245 via pivots 131 and 133. Line 137 crossing these two pivots is the primary parallelogram line. A thrust bearing 237 allows lead screw 238 to rotate and supports its load to the bearing housing 236 which is pivotally attached to the abduction carriage via pivot 132. Hand crank 139 and screw nut 239 together control the position of the parallelogram mechanism 230. The parallelogram mechanism 230 comprises members 231, 232, 233, 234 and 235. Member 235 is supported via pivots 135 and 136. A secondary parallelogram 138 line crosses the centers of pivots 135 and 136. Primary and secondary parallelogram lines 137 and 138 intersect along a virtual axis VA 2. As the parallelogram mechanism moves, member 235 rotates around VA 2. Rotation support plate 210 is firmly attached to member 235 and serves as a housing for the pivots of leg rotation mechanism 220. The position of member 235 shown is close to the lowest position of the parallelogram mechanism which corresponds to leg extension.

The parallelogram mechanism 230 is shown in a position corresponding to leg extension in FIG. 12 and leg flexion in FIG. 13. Member 235 rotates around VA 2 as the parallelogram mechanism is raised by rotating hand crank and lead screw 238.

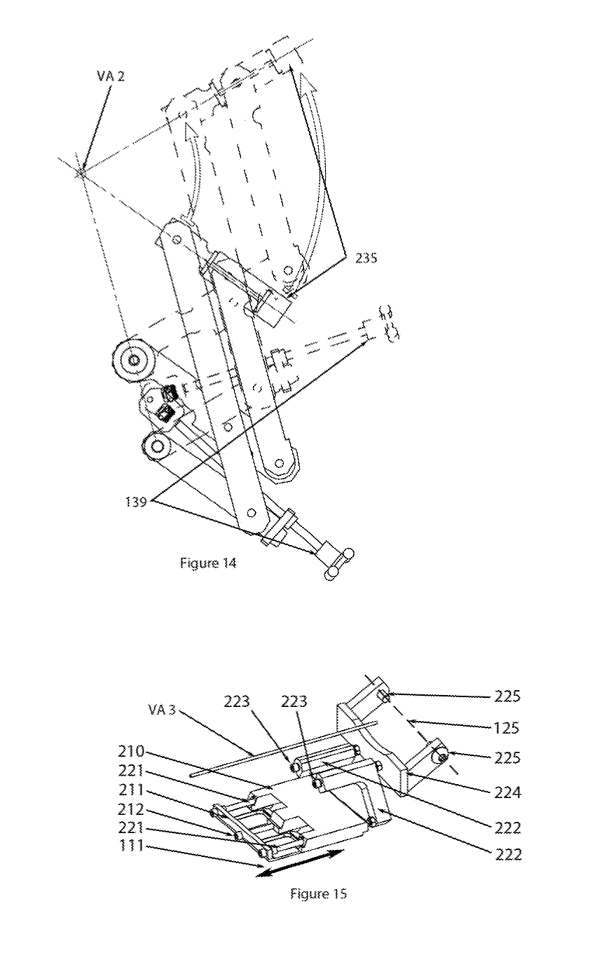

FIG. 14 is a composite drawing depicting two position of the parallelogram mechanism 230. The movement is controlled by rotating hand crank 139 which moves up as the mechanism is raised. Member 235 rotates around VA 2. Parallelogram mechanism 230 allows member 235 to be raised further up than shown on FIG. 14.

Rotation support plate 210 houses two pivots 221 connecting the arms 222 of the leg rotation mechanism 220 to the upper leg length adjustment bracket 211 used to control and compensate for differences in the length of the upper leg, as shown in FIG. 15. Adjustment screw 212 supports and moves bracket 211 along the length of the pivots 221 as shown by arrow 111. Leg rotating arms 222 rotate around pivots 221 and support distraction frame 224 through secondary pivots 223, causing the distraction pivoting frame 224 to rotate around virtual Axis VA 3. VA 3 is generally going through the area occupied by the knee and through the hip joint.

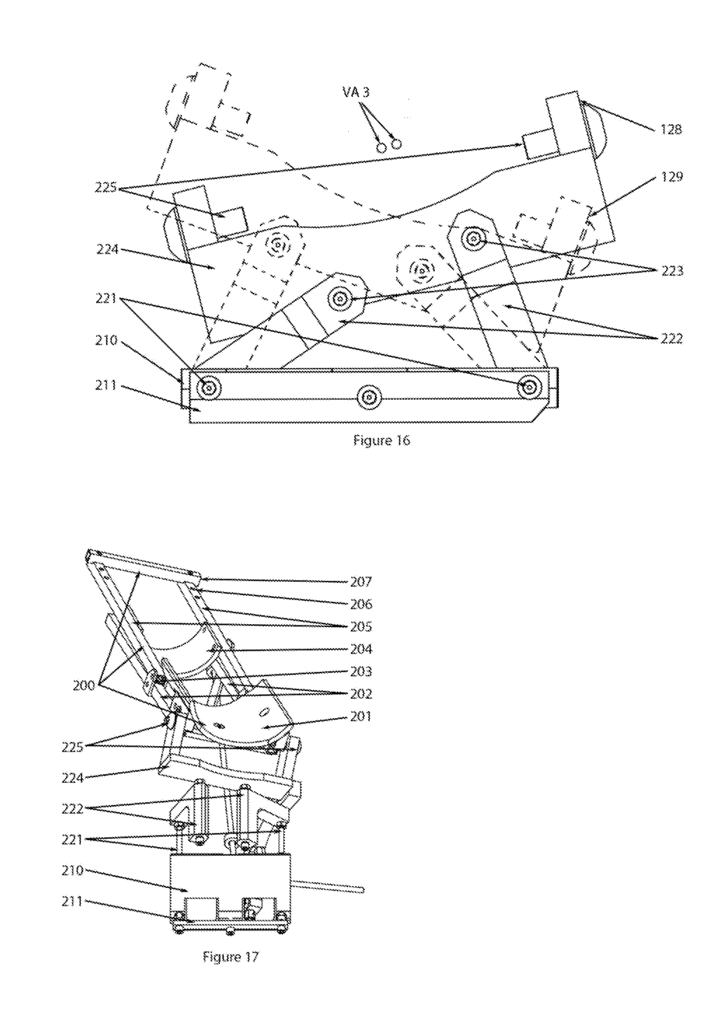

The leg rotation mechanism 220 is shown in two positions relative to rotation support plate 210 of distraction frame 224 and the upper leg length adjustment bracket 211 in FIG. 16. Position 128 is shown in solid line and position 129 in dashed line. Arms 222 are pivotally attached to the rotation support plate 210 via pivots 221. The distraction frame 224 is pivotally attached to the arms 222 via pivots 223. Distraction frame 224 rotates around VA-3 which dynamically moves with the movement of frame 224 but generally remains in a small area. Two positions of VA-3 are shown on FIG. 15. The distraction frame 224 supports the distraction assembly 200 via two pivots 225. Pivots 225 form an axis of rotation, and distraction assembly 200 rotates together with distraction frame 224 around VA-3.

Distraction assembly 200 along with distraction frame 224 are shown in positions which are to the left of the central position when viewed from atop rotational plate 210 in FIG. 17. Distraction assembly 200 comprises a main calf support 201, rear side rails 202, a rail connector 203,a lower leg support 204, front side rails 205, and an ankle bar 207. Multiple adjustments holes 206 on front side rails 205 allow ankle bar 207 to be assembled in various positions to the front side rails 205. Distraction frame 224 is connected to rotational support plate 210 via pivots 221 and arms 222. Adjustment bracket 211 defines the longitudinal position of pivots 221.

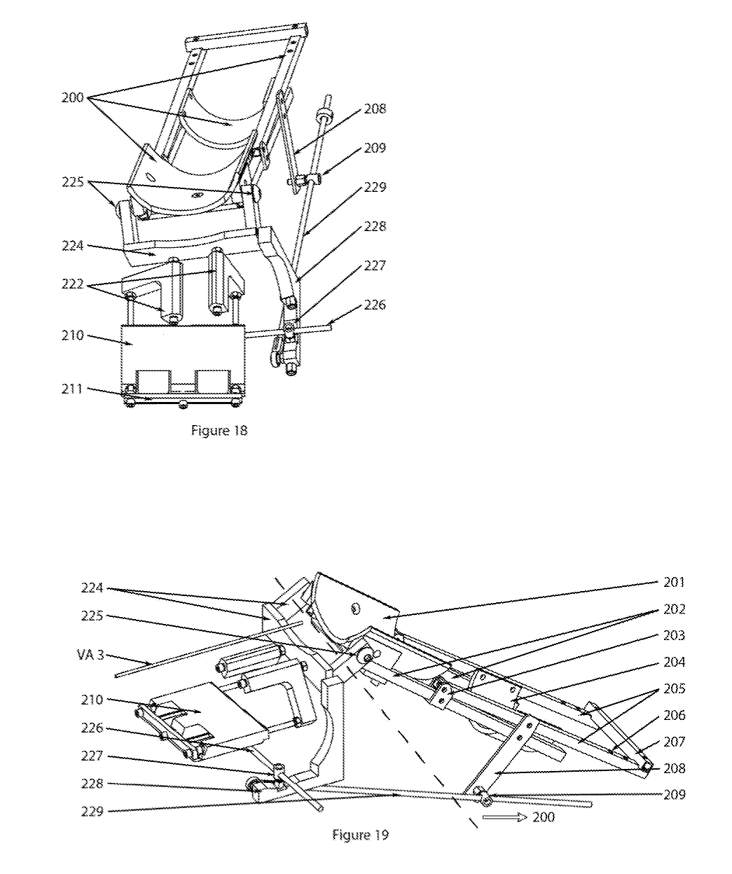

Distraction assembly 200 along with distraction frame 224 are shown in positions which are to the right of the central position when viewed from atop rotational plate 210 in FIG. 18. The movement of distraction frame 224 relative to rotational support plate 210 is supported by arms 222 and can be locked in any position by tightening lock 227 to positioning bar 226. Collars 291 and 292 are selectively positionable along the bar 226 to allow for both locking and repositioning of the mechanism. To reposition, one of the collars is left in place so that the bar can later be returned to precisely the same position. Distraction assembly 200 can be rotated around the axis defined by pivots 225 and can be locked in any position by tightening lock 209 to a long positioning bar 229. Lock 209 is attached to lock support plate 208. Collars 293 and 294 are selectively positionable along the bar 229 to allow locking and repositioning of the distraction assembly in a manner similar to that described with respect to collars 291 and 292. Lock 227 and long positioning bar 229 are attached to locking bracket 228. Adjustment bracket 211 defines the longitudinal position of pivots 221.

As shown in FIG. 19, distraction assembly 200 comprises components to the left of the dashed line except for pivots 225. A calf support 201 is mounted to the rear rails 202. A lower leg support 204 is mounted to the front side rails 205. Front side rails 205 are connected to the rear side rails 202 via rail connectors 203 and lock support plate 208. Multiple adjustments holes 206 on front side rails 205 allow ankle bar 207 to be assembled in various positions to the front side rails 205. The distraction assembly 200 along with distraction frame 224 rotates relative to rotational support plate 210 around VA-3. This rotation can be locked in any position by tightening lock 227 (mounted to locking bracket 228) to positioning bar 226. Distraction assembly 200 rotates relative to distraction frame 224 around the axis defined by pivots 225. This rotation can be locked by tightening lock 209 which is mounted on lock plate 208.

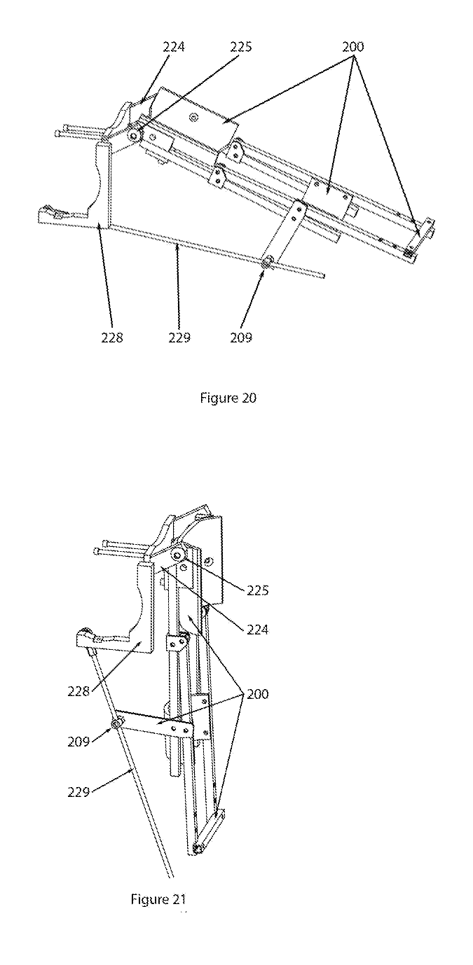

Distraction assembly 200 rotates around pivots 225 relative to distraction frame 224 and is shown in a relatively horizontal position in FIG. 20, which is usually the initial position prior to distraction. Rotation of distraction assembly 200 is locked by tightening lock 209 to long positioning bar 229 which is attached to locking bracket 228.

Distraction assembly 200 rotates around pivots 225 relative to distraction frame 224 and is shown in a relatively vertical position, which may be the final distraction position in FIG. 21. Rotation of distraction assembly 200 is locked by tightening lock 209 to long positioning bar 229 which is attached to locking bracket 228.

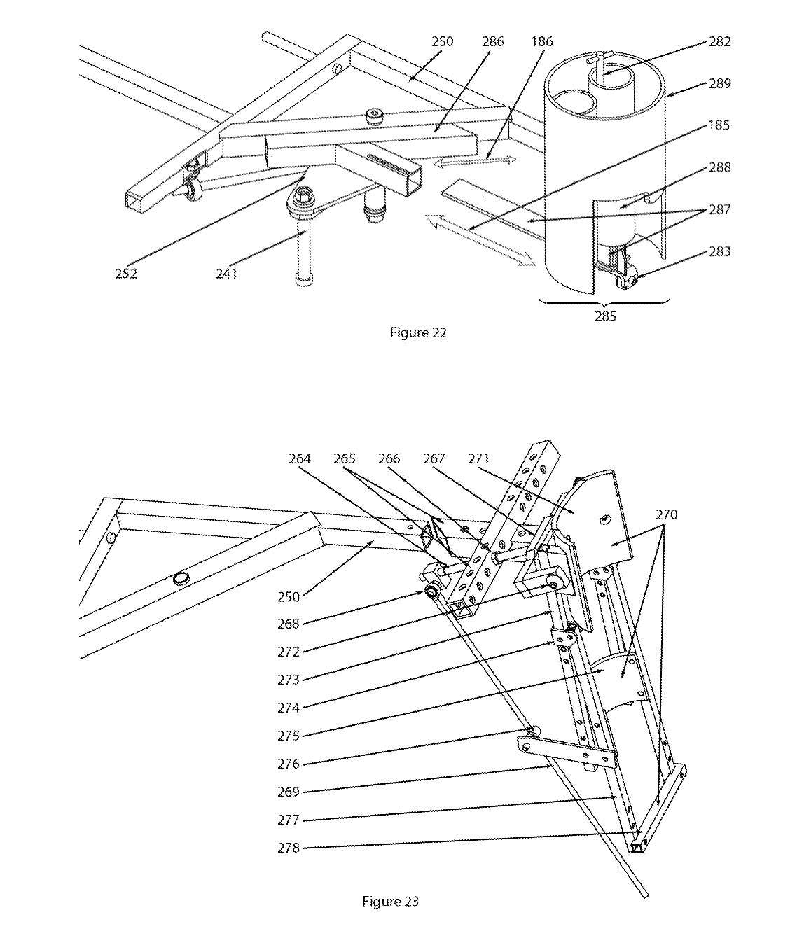

The peroneal post 285 comprises components 282, 283, 287, 288 and 289 as shown in FIG. 22. A peroneal mounting bracket 286 is attached to main frame 250 and can move along in a direction shown by arrow 186. The peroneal mounting bracket 286 is locked to main frame 250 prior to installing peroneal post 285. The peroneal post frame 287 slides atop bracket 286 in direction shown by arrow 185 and can be moved by tightening the tensioner 283. After positioning in a desired location it is locked in position by tightening the peroneal post lock 282. An inner body 288 is attached to the peroneal post frame 287 and outer body 289 is secured around the inner body 288. Components 241 and 252 are shown for clarity. Usually, the peroneal post 285 will initially be movable and be locked to the bracket 286 only after it has been properly positioned relative to the patient. The patient will first lie on the table and will be positioned so that the hip joint is aligned with the virtual point of rotation defined by the pivotal and rotational assemblies as described above. Conveniently, the vertical alignment axis can be marked on the main frame 250. The peroneal post is then positioned against the patient's groin with a slight pressure.

A passive leg support subframe 265 attached to the main frame 250 is shown in FIG. 23. Subframe 265 slides over main frame 250, and multiple holes in subframe 265 ensure mounting flexibility both with main frame 250 and with shaft 264. Passive leg support 270 rotates around the longitudinal axis of shaft 264, and the distance between frame 267 and subframe 265 is maintained and adjusted by multiple hex nuts 266. Frame 267 has two pivots 272 allowing passive leg support 270 to rotate around the axis formed be pivots 272. This rotation is controlled and maintained by tightening lock 276 to long positioning bar. 269 at any position along the bar 269. Long positioning bar 269 is attached through a ball joint to the shaft 264. Passive leg support consist of calf support 271, lower leg support 275, rear rails 273, rail brackets 274, front rails 277 and ankle bar 278. Multiple holes in both rear rails 273 and front rails 277 ensure multiple assembly choices.

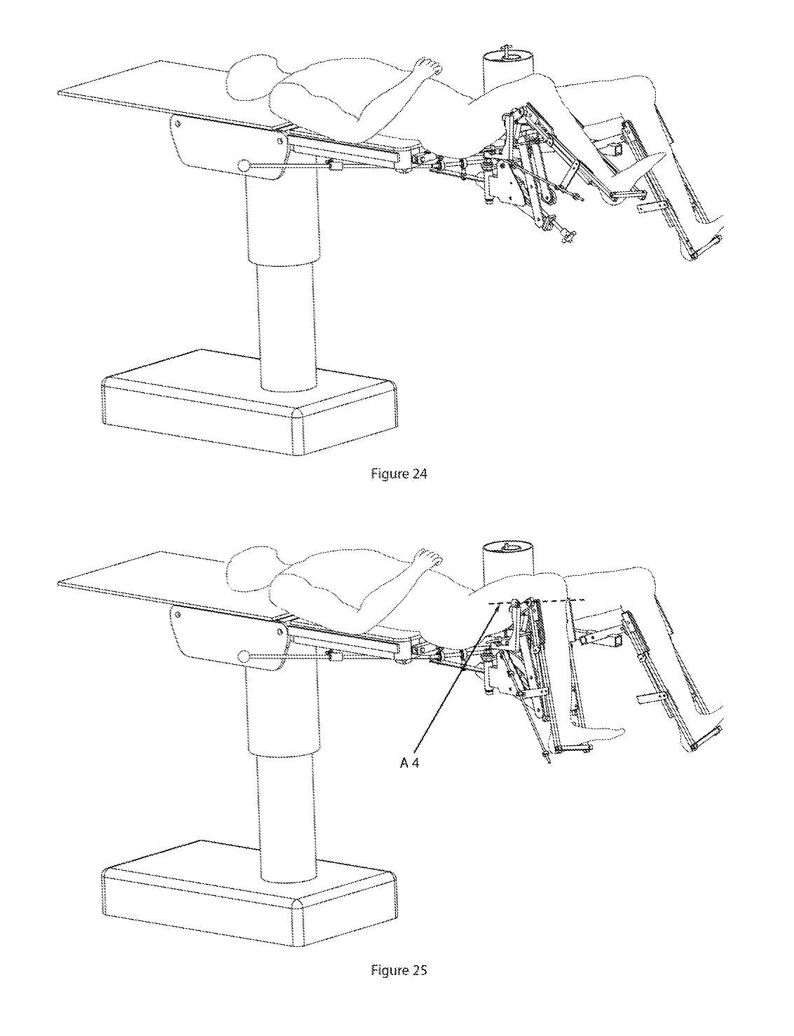

A patient placed on the PDA with a right leg to be distracted and a left passive leg is shown in FIG. 24.

As shown in FIG. 25, Leg distraction is performed by rotating distraction assembly 200 around the axis A-4. Axis A-4 is relatively horizontal and is parallel to the natural axis of bending the knee.

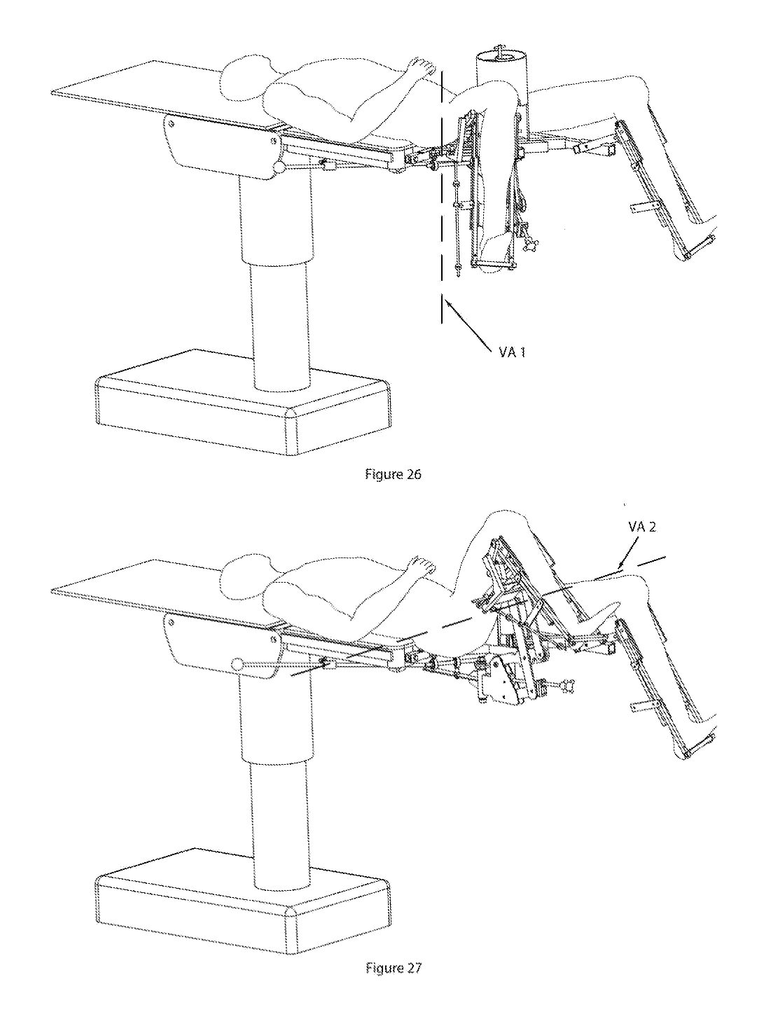

As shown in FIG. 26, the distracted leg may be rotated around axis VA-1 to perform abduction (when compared to position on FIG. 25). VA-1 is relatively vertical and goes through or close to the center of rotation of the femoral head, as shown in FIG. 1.

As shown in FIG. 27, the distracted leg is raised up in flexion and rotated around VA-2 (when compared to the position on FIG. 25). VA-2 is relatively horizontal and goes through or close to the center of rotation of the femoral head.

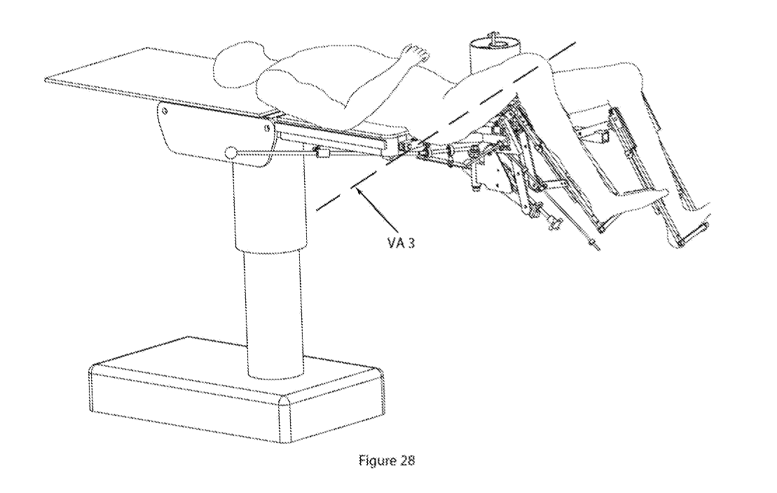

As shown in FIG. 28, the lower leg is moved inward and the distracted leg is rotated around VA-3 in lateral rotation (when compared to FIG. 25). VA-3 goes through or close to the femoral head and the knee.

What is claimed is:

1. A method for distracting a patient's hip joint, said method comprising:
supporting a leg with a knee bent in a repositionable leg support with the hip distracted;
repositioning the leg support in a first plane while the hip joint remains distracted at a fixed point of rotation;
repositioning the leg support in a second plane perpendicular to the first plane while the hip joint remains distracted at the fixed point of rotation; and
rotating the leg support about an axis generally aligned with the femur and intersecting the fixed point of rotation while the hip joint remains distracted at the fixed point of rotation.

2. A method as in claim 1, further comprising bending the knee while the leg support engages the lower leg at a fulcrum point below the knee so that the lower leg acts as a lever to apply tension to the upper leg to distract the hip joint.

3. A method as in claim 1, further comprising advancing a fulcrum which engages the lower leg at a point below the knee while immobilizing the ankle to apply tension to the upper leg to distract the hip joint.

4. A method as in claim 1, wherein the leg support is prevented from being repositioned in the second plane and from being rotated while the leg support is being repositioned in the first plane.

5. A method as in claim 1, wherein the leg support is prevented from being repositioned in the first plane and from being rotated while the leg support is being repositioned in the second plane.

6. A method as in claim 1, wherein the leg support is prevented from being repositioned in the first and second panes while it is being rotated.

7. A method for distracting a patient's hip joint, said method comprising:
immobilizing the patient's hip joint on a table with the hip joint at a point of rotation;
applying tension to the patient's femur to distract the hip joint;
pivoting the lower leg and femur in a first plane while the hip joint remains distracted and at the part of rotation;
pivoting the lower leg and femur in a second plane perpendicular to the first plane while the hip joint remains distracted and positioned at the point of rotation; and
rotating the lower leg about an axis of rotation aligned with the femur and intersecting the point of rotation while the hip joint remains distracted and at the point of rotation.

8. A method as in claim 7, wherein the torso is immobilized in a supine position.

9. A method as in claim 7, wherein the torso is immobilized in a lateral position.

10. A method as in claim 7, wherein immobilizing comprises positioning the patient's groin over a post.

11. A method as in claim 10, further comprising positioning the peroneal post in a desired position against the patient's groin and locking the post relative to the table after the post has been positioned.

12. A method as in claim 7, wherein applying tension to the femur comprises:
flexing the knee with a location on the lower leg held against a fulcrum structure so that the knee is drawn away from the torso to distract the hip joint.

13. A method as in claim 12, wherein the fulcrum structure comprises an upper end of a leg support which holds the lower leg.

14. A method as in claim 7, wherein applying tension comprises advancing a fulcrum which engages the lower leg at a point below the knee while immobilizing the ankle to apply tension to the upper leg to distract the hip joint.

15. A method as in claim 7, wherein pivoting the lower leg and femur in the first plane comprises engaging the lower leg or upper leg and moving the leg through an arc in the first plane.

16. A method as in claim 15, wherein engaging comprises securing the leg in a leg support which is mechanically constrained to allow movement of the leg in the first plane without moving the location of the hip joint.

17. A method as in claim 16, wherein engaging further comprises manually repositioning the leg or leg support.

18. A method as in claim 16, wherein engaging further comprises actuating a mechanism to move the leg or leg support.

19. A method as in claim 7, wherein pivoting the lower leg and femur in the second plane comprises engaging the lower leg or upper leg and moving the leg through an arc in the plane.

20. A method as in claim 19, wherein engaging comprises securing the leg in a leg support which is mechanically constrained to allow movement and the leg in the second plane without moving the location of the hip joint.

21. A method as in claim 20, wherein engaging further comprises manually repositioning the leg or leg support.

22. A method as in claim 20, wherein engaging further comprises actuating a mechanism to move the leg support.

23. A method as in claim 7, wherein rotating the lower leg about the axis of rotation comprises engaging the lower leg and applying torque to rotate the leg lower through in a plane normal to the axis.

24. A method as in claim 23, wherein engaging comprises securing the leg in a leg support which is mechanically constrained to allow rotation of the lower leg without moving the location of the hip joint.

25. A method as in claim 24, wherein engaging further comprises manually repositioning the lower leg or leg support.

26. A method as in claim 25, wherein engaging further comprises actuating a mechanism to move the leg support.

27. A method as in claim 7, wherein the patient is under a surgical drape and repositioning comprises moving actuator mechanisms lying outside of the surgical drape.

28. A method as in claim 7, further comprising (1) indexing at a first time the position of the leg in at least one of the first plane, the second plane, the rotational orientation about the axis of rotation, and the degree of distraction and (2) repositioning the leg to said indexed position at a subsequent time.

29. A system for distracting and repositioning a hip joint, said system comprising:
a frame which defines a virtual point of rotation, wherein the frame is adapted to be positioned relative to a patient so that the virtual point of rotation is coincident with the patient's hip joint;
a leg support having a lower leg attachment member pivotally attached to a bracket;
a first pivot assembly mechanically coupling the bracket to the frame and constraining the leg support to travel in an arc-like path in a first plane relative to the virtual point of rotation;
a second pivot assembly mechanically coupling the bracket to the front and constraining the leg support to travel in an arc in a second plane which is perpendicular to the first plane relative to the virtual pint of rotation, and
a rotation assembly mechanically coupling the bracket to the frame and constraining the bracket to be rotated about an axis extending radially from the virtual point of rotation.

30. A system as in claim 29, wherein each of the first pivot assembly, the second pivot assembly, and the rotation assembly is lockable so that pivotal and rotational movement of the leg support can be selectively allowed and prevented.

31. A system as in claim 29, wherein the virtual point of rotation is sufficiently offset from all mechanical components of the system so that the hip joint is surgically accessible regardless of the position of the leg support.

32. A system as in claim 29, wherein the frame is adapted to be removably connected to a surgical table.

33. A system as in claim 29, wherein the leg support further comprises a lock for selectively immobilizing the attachment member relative to the bracket.

34. A system as in claim 33, wherein the lower leg member allows the patient's lower leg to be secured at different positions so that the knee can be raised and lowered relative to the bracket.

35. A system as in claim 29, wherein the first pivot assembly comprises a support arm and a linkage assembly, wherein the linkage assembly is attached to the frame and the support arm is coupled to the secured pivot assembly, wherein the linkage assembly allows the support arm to reposition the leg support around the virtual point of rotation in the first place.

36. A system as in claim 35, wherein the second pivot assembly comprises a linkage assembly which is attached between the first pivot assembly and the rotation assembly, wherein the second pivot assembly allows the leg support to be repositioned around the virtual point of rotation in the second plane.

37. A system as in claim 36, wherein the linkage of the second pivot assembly comprises a parallelogram structure.

38. A system as in claim 36, wherein the second pivot assembly further comprises a driver adapted to control the parallelogram structure to effect movement of the leg support.

39. A system as in claim 36, wherein the rotation assembly comprises a rocker assembly attached between the second pivot assembly and the bracket of the leg support, wherein the rocker assembly allows the leg support to be rotated about the axis.

40. A system as in claim 29, further comprising means for indexing a position of the leg support, the first pivot assembly, the second pivot assembly, and the rotation assembly during distraction or repositioning procedure, wherein said means allows any one or more of the assemblies to be returned to any position that has been indexed.

41. A system as in claim 40, wherein the means for indexing comprises collars repositionably mounted on components of the assemblies.

42. A method for distracting a patient's hip, said method comprising:
engaging a lower leg of the patient against a fulcrum structure below a knee; and
flexing the knee while the lower leg remains engaged against the fulcrum structure, wherein a tension is applied to a femur to distract the hip.
